(19) United States
(12) Patent Application Publication
(10) Pub. No.: US 2002/0186433 A1
(43) Pub. Date: Dec. 12, 2002

(54) Routing and switching in a hybrid network

(76) Inventor: Manav Mishra, Hillsboro, OR (US)

Correspondence Address: Jan Carol Little, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/881,448

(22) Filed: Jun. 12, 2001

(51) Int. Cl. H04B 10/20; H04J 14/00; H04J 14/02

(52) U.S. Cl. 359/128; 359/118

(57) ABSTRACT

A protocol-independent framework that facilitates routing and switching in a network that has hybrid nodes is described. Using the framework, optical paths are established between and among nodes statically and dynamically. When the paths are established dynamically, the paths maybe explicitly established or shared. Traffic is transported using switching wavelengths, routing wavelengths, and/or control wavelengths. Traffic transported on switching wavelengths is switched in the optical domain. Traffic transported on routing wavelengths is routed according to the OSI reference model.

### BACKGROUND OF THE INVENTION

1. Field of the Invention

The present invention is related to communication networks and, in particular, to routing and switching in hybrid communication networks.

2. Background of the Invention

Current networking technologies are moving towards optical networks while still honoring existing legacy networks. This is due in part to the push for faster access and more bandwidth. Optical networks and legacy networks typically use different switching technologies, however, and networks that are hybrids of legacy technologies and optical technologies are difficult to design and administer.

For example, legacy networks typically use packet switching in which nodes share bandwidth with each other by exchanging packets. As a packet travels from one network element to the next in the network, each network element makes an independent forwarding decision for that packet. That is, each network element analyzes the packet's header and each network element runs a network layer routing algorithm. Each network element independently chooses a next hop for the packet based on its analysis of the packet's header and the results of running the routing algorithm. Packet switched networks are generally regarded as slow. Moreover, there is usually no guarantee that a packet will reach its intended destination.

Multi-Protocol Label Switching (MPLS) technology is intended to speed up packet switched traffic flow. Choosing the next hop can therefore be thought of as the composition of two functions. The first function partitions the entire set of possible packets into a set of “Forwarding Equivalence Classes (FECs).” The second function maps each FEC to a next hop. Insofar as the forwarding decision is concerned, different packets that get mapped into the same FEC are indistinguishable. All packets that belong to a particular FEC and that travel from a particular node will follow the same path. Alternatively, if certain kinds of multipath routings are in use, the packets will follow one of a set of paths associated with the FEC.

In conventional Internet Protocol (IP) forwarding, a particular network element will typically consider two packets to be in the same FEC if there is some address prefix in that network element's routing tables such that the address prefix is the “longest match” for each packet's destination address. As the packet traverses the network, each hop in turn reexamines the packet and assigns it to a FEC.

In MPLS, the assignment of a particular packet to a particular FEC is done just once, as the packet enters the network. The FEC to which the packet is assigned is encoded as a short fixed length value known as a “label.” When a packet is forwarded to its next hop, the label is sent along with it. That is, the packets are “labeled” before they are forwarded. At subsequent hops, there is no further analysis of the packet's network layer header. Rather, the label is used as an index into a table, which specifies the next hop and a new label. The old label is replaced with the new label and the packet is forwarded to its next hop.

In the MPLS forwarding paradigm, once a packet is assigned to a FEC there is no further header analysis done by subsequent network elements. Instead, the labels drive all forwarding. This has a number of advantages over conventional network layer forwarding.

Optical networks typically use circuit switching in which a dedicated physical circuit path exists between sender and receiver for the duration of a “call.” Circuit switched networks are generally regarded as high-speed and there is certainty that information will reach its intended destination. However, in circuit switched networks, bandwidth is dedicated between two machines and no others may access the bandwidth. If all the bandwidth is not being utilized, the unutilized portion is wasted because there is no sharing.

As a counterpart to MPLS, Multi-Protocol Lambda Switching (or photonic switching, lambda switching, wavelength switching) is a technology used in optical networks to switch individual wavelengths of light onto separate paths for specific routing information. When used with dense wavelength division multiplexing (DWDM) wavelength switching enables a light path to behave as a virtual circuit does. DWDM is an optical technology that multiplexes data signals from different sources onto a fiber optic strand. Each data signal is carried on its own separate wavelength (or channel). Because each channel is demultiplexed at the end of transmission back into its original source different data formats being transmitted at different data rates can be transmitted together. Wavelength switching allows network elements and switches to perform necessary functions automatically without having to extract instructions from packets.

### BRIEF DESCRIPTION OF THE DRAWINGS

The invention is best understood by reference to the figures wherein references with like reference numbers generally indicate identical, functionally similar, and/or structurally similar elements. The drawing in which an element first appears is indicated by the leftmost digit(s) in the reference number in which:

FIG. 1 is a high-level block diagram of an example network suitable for implementing embodiments of the present invention;

FIG. 2 is a high-level block diagram of example architecture for a hybrid network node suitable for implementing embodiments of the present invention;

FIG. 3 is a schematic diagram of an example approach to implementing static provisioning of optical circuits according to embodiments of the present invention;

FIG. 4 is a flowchart illustrating an example approach to static provisioning of bandwidth according to embodiments of the present invention;

FIG. 5 is a schematic diagram of an example approach to implementing explicit provisioning of optical circuits according to embodiments of the present invention;

FIG. 6 is a flowchart illustrating an example approach to dynamic provisioning of bandwidth according to embodiments of the present invention;

FIG. 7 is a schematic diagram of an example approach to implementing shared explicit provisioning of optical circuits according to embodiments of the present invention; and

FIG. 8 is a flowchart illustrating an example approach to shared provisioning according to embodiments of the present invention;

### DETAILED DESCRIPTION OF THE ILLUSTRATED EMBODIMENTS

Routing and switching in a hybrid optical network is described herein. In the following description, numerous specific details, such as particular processes, materials, devices, and so forth, are presented to provide a thorough understanding of embodiments of the invention. One skilled in the relevant art will recognize, however, that the invention can be practiced without one or more of the specific details, or with other methods, components, etc. In other instances, well-known structures or operations are not shown or described in detail to avoid obscuring aspects of various embodiments of the invention.

Some parts of the description will be presented using terms such as switch, network element, wavelength, network, network elements, nodes, and so forth. These terms are commonly employed by those skilled in the art to convey the substance of their work to others skilled in the art.

Other parts of the description will be presented in terms of operations performed by a computer system, using terms such as receiving, detecting, collecting, transmitting, and so forth. As is well understood by those skilled in the art, these quantities and operations take the form of electrical, magnetic, or optical signals capable of being stored, transferred, combined, and otherwise manipulated through mechanical and electrical components of a computer system; and the term “computer system” includes general purpose as well as special purpose data processing machines, systems, and the like, that are standalone, adjunct or embedded.

Various operations will be described as multiple discrete steps performed in turn in a manner that is most helpful in understanding the invention. However, the order in which they are described should not be construed to imply that these operations are necessarily order dependent or that the operations be performed in the order in which the steps are presented.

Reference throughout this specification to “one embodiment” or “an embodiment” means that a particular feature, structure, process, step, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

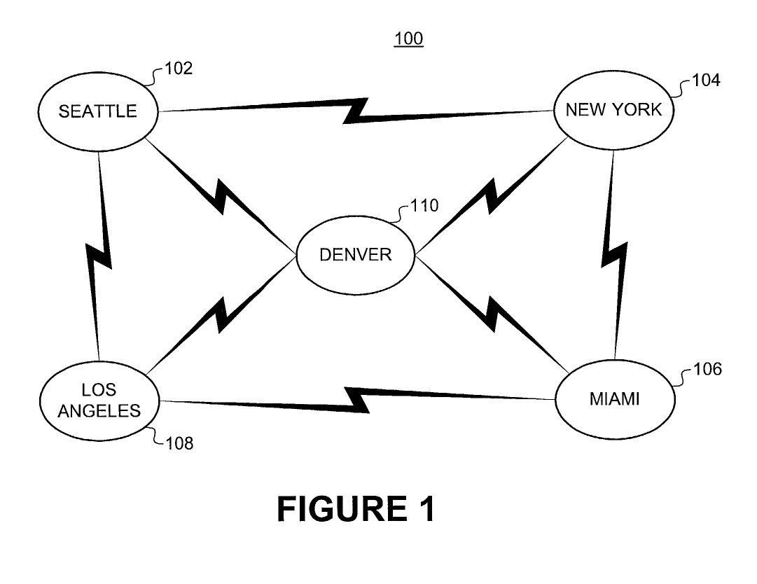

FIG. 1 is a schematic diagram of an example hybrid network 100, which may be an optical wide area network (WAN), which may have a mesh topology or other suitable topology. The example network 100 implements a protocol-independent framework that facilitates traffic transport using packet routing and optical circuit switching. For example, the example network 100 may implement Open Shortest Path First (OSPF), Resource Reservation Protocol (RSVP), and/or Border Gateway Protocol (BGP).

As FIG. 1 illustrates, the example network 100 includes one or more hybrid nodes, including in Seattle (102), New York (104), Miami (106), Los Angeles (108), and Denver (110). Each of the hybrid nodes has networking protocol functionality over dense wavelength division multiplexing (DWDM) functionality. In one embodiment, the networking protocol functionality supports Internet Protocol (IP) routing, asynchronous transport mode (ATM), frame relay, or other networking protocol. In one embodiment, the DWDM functionality supports optical circuit switching.

Traffic in the example network 100 may be routed traffic, switched traffic, and/or control traffic. Routed traffic typically undergoes an optical-to-electrical conversion, software processing, and a conversion back to the optical domain from the electrical domain in accordance with the well-known Open Systems Interconnection (OSI) reference model. Switched traffic typically does not function according to the OSI reference model and as a result can be transported much faster than routed traffic. Control traffic is signaling and control information exchanged among hybrid nodes.

In one embodiment, one set of wavelengths (one or more switching wavelengths) may be used as labels to indicate that the traffic is to be switched in the optical domain using the optical circuit switching. Another set of wavelengths (one or more routing wavelengths) may be used as labels to indicate that traffic is to be routed. In one embodiment, control traffic is carried on a set of control wavelength(s), which may be a dedicated out-of-band wavelength or a dedicated in-band wavelength.

The network 100 in one embodiment implements “best effort switching.” In this embodiment, the hybrid network element attempts to switch all traffic using switching wavelengths. If the hybrid network element cannot switch all traffic, the hybrid network element routes the traffic that cannot be switched using routing wavelengths. This increases the likelihood that the faster optical switching is chosen as the first mechanism to transport traffic and the slower packet routing is chosen only when optical switching is not feasible.

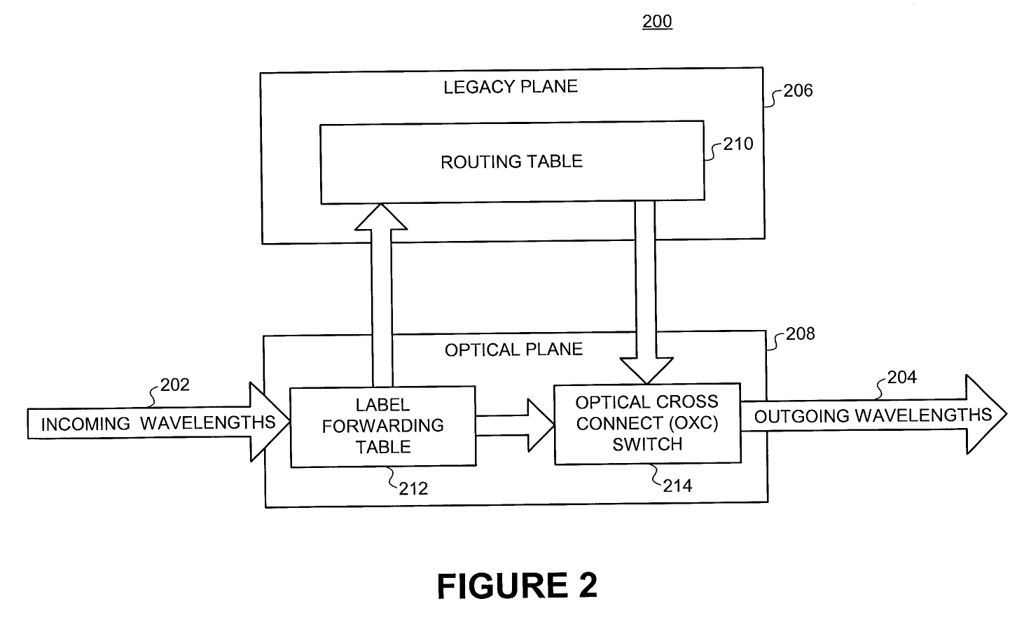

FIG. 2 is a high-level block diagram of an example hybrid network element 200 according to an embodiment of the present invention. The example hybrid network element 200 may be a router, a switch, a gateway, or the like, that includes the functionalities described herein. In one embodiment, the hybrid network element 200 implements any routing algorithm compatible with well-known legacy network element protocols, including OSPF, RSVP, and BGP. Of course, the hybrid network element 200 may implement routing algorithms compatible with other routing protocols.

The example hybrid network element 200 may be located in one or more network elements in the nodes in Seattle (102), New York (104), Miami (106), Los Angeles (108), and/or Denver (110). The hybrid network element 200 receives switched traffic, routed traffic, and/or control traffic from upstream network elements on incoming wavelengths 202 and sends traffic to downstream network elements on outgoing wavelengths 204. Each hybrid network element in the network 100 passes routing updates to other hybrid network elements via the control wavelength(s). For example, each hybrid network element advertises its wavelengths (or labels) so that neighboring hybrid network elements can use the labels to communicate with the advertising hybrid network element. Label information may be appended to the routing updates.

The hybrid network element 200 uses the routing updates and label information to generate a label map, which is a plan outlining wavelengths that are used in the network 100, including the number of channels, channel spacing, channel widths, and channel center wavelengths. The label map is used to generate a switching matrix, which outlines how specific wavelengths are deflected from one path to another (typically from one optical fiber to another).

The illustrated example hybrid network element 200 includes a legacy plane 206 and an optical plane 208. The legacy plane 206 includes a routing table 210. The optical plane 208 includes a label-forwarding table 212 and an optical cross-connect switch OXC 214.

The legacy plane 206 supports a variety of legacy networking protocols. In one embodiment, the legacy plane 206 supports Internet Protocol (IP) and routes packets according the OSI reference model. Of course, implementation of the present invention is not so limited. For example, in other embodiments, the legacy plane 202 supports asynchronous transport mode (ATM) and frame relay.

In one embodiment, the optical plane 208 determines whether an incoming wavelength 202 is a switching wavelength, a routing wavelength, or a control wavelength. When the optical plane 208 determines that an incoming wavelength 202 is a switching wavelength, the optical plane 208 sends the switching wavelength to the OXC 214. When the optical plane 208 determines that an incoming wavelength 202 is a routing wavelength, the optical plane 208 sends the routing wavelength to the routing table 210 in the legacy plane 206 via the label-forwarding table 212.

In one embodiment, the routing table 210 stores routing updates and label information. The routing table 210 also may keep track of metrics associated with the routes.

In one embodiment, the label-forwarding table 212 receives the routing updates and label information, generates the label map and the switching matrix, and stores the switching matrix.

The OXC 214 is intended to represent a device that implements DWDM such that multiple incoming wavelengths each carrying a separate data stream are combined on a single optical fiber and then separated again at the receiving end (e.g., the next hybrid network element). Such device may be an optical switch, an optical network element, a lambda switch network element, or the like, that switches traffic in the optical domain. In one embodiment, the OXC 214 accesses the switching matrix from the label-forwarding table 212 and switches traffic based on the switching matrix.

The example network 100 may provision bandwidth statically or dynamically. Paths may be explicitly switched, explicitly routed, or shared between switching and routing.

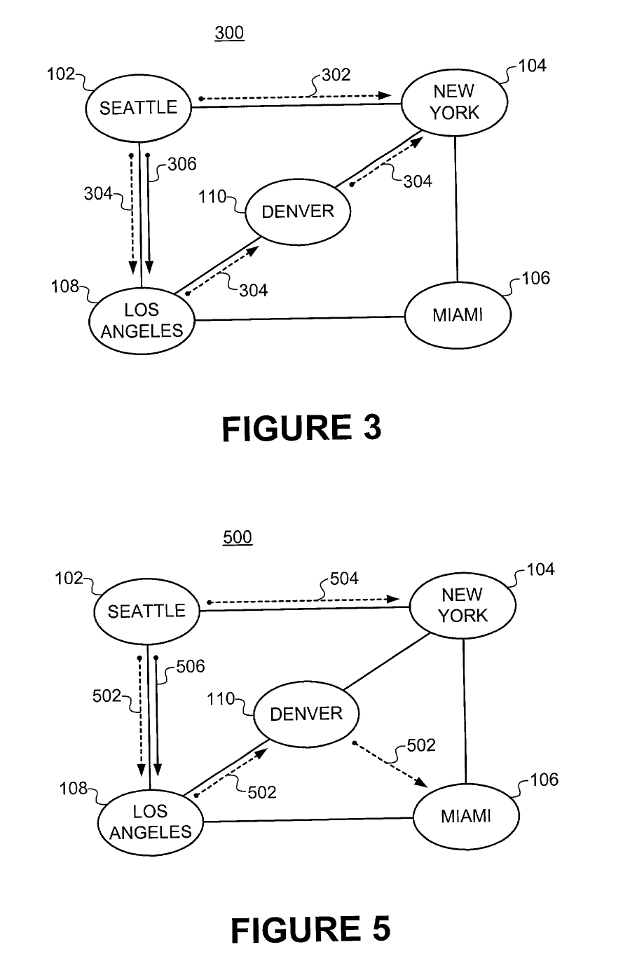

FIG. 3 illustrates an example approach to static bandwidth provisioning using a backbone 300 that has the Seattle node 102 linked to the New York node 104 and the Los Angeles node 108, the New York node 104 linked to the Miami node 106, and the Miami node 106 linked to the Los Angeles node 108. The Denver node 110 is linked between the Los Angeles node 108 and the New York node 104. For purpose of illustration suppose that the traffic between the Seattle node 102 and the New York node 104 is one hundred fifty percent of allocated bandwidth and traffic between the Seattle node 102 linked and the Los Angeles node 108 is thirty percent of allocated bandwidth.

In one embodiment of the present invention, one hundred percent of the traffic destined for the New York node 104 from the Seattle node 102 is statically switched (provisioned) between the Seattle node 102 and the New York node 104. The remaining fifty percent of the traffic destined for the New York node 104 from the Seattle node 102 is statically switched (provisioned) between the Seattle node 102 and the New York node 104 by way of the Los Angeles node 108 and the Denver node 110. This ensures that the link between the between the Seattle node 102 and the New York node 104 utilizes no more than one hundred percent of its allocated bandwidth.

The arrow 302 illustrates the statically switched path between the Seattle node 102 and the New York node 104. The arrow 304 illustrates the statically switched path between the Seattle node 102 and the New York node 104 via the Los Angeles node 108 and the Denver node 110. The arrow 306 illustrates the statically switched path between the Seattle node 102 and the Los Angeles node 108.

The switching is accomplished using switching wavelengths. For example, suppose there are ten switching wavelengths available to switch traffic between a particular link. When this is the case, ten switching wavelengths may be assigned as labels for traffic between the Seattle node 102 and the New York node 104. Three switching wavelengths may be assigned to traffic between the Seattle node 102 and the Los Angeles node 108, which corresponds to traffic between the Seattle node 102 and the Los Angeles node 108 being thirty percent of allocated bandwidth. Five of the remaining seven switching wavelengths allocated to the link between the Seattle node 102 and the Los Angeles node 108 are assigned to traffic destined for the New York node 104 from the Seattle node 102 but that is switched via the Los Angeles node 108 and the Denver node 110.

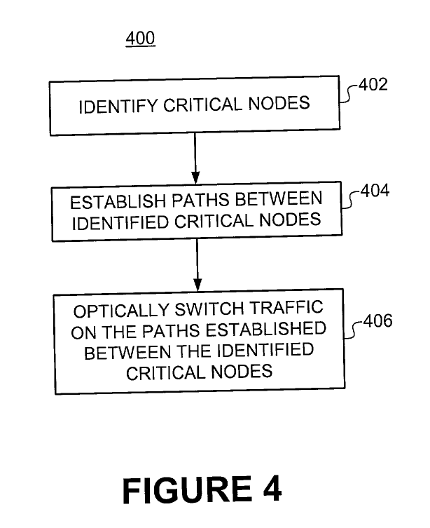

Static provisioning is typically performed after a service provider has performed traffic pattern studies, load analyses, and the like such that when provisioning service, the service provider knows the status a priori. FIG. 4 is a flowchart illustrating a process 400 to implement an example approach to static provisioning. In step 402, the service provider identifies critical nodes in the example network 100. In step 404, the service provider establishes paths between the identified critical nodes. In step 406, traffic is optically switched between the nodes.

Of course, other traffic in the network may be routed through the network 100 on routing wavelengths. Each packet in routed traffic includes IP addresses for all hops in the path. Routed traffic is slower, however. This is because the incoming wavelengths 112 are converted from an optical signal to an electrical signal. Each packet in the traffic is routed up the OSI Reference Model layers and undergoes software processing. Each packet is then routed down the OSI Reference Model layers and converted back to an optical signal.

In contrast, switched traffic does not experience the same delays as routed traffic because switched traffic is not converted to the electrical domain nor does it transit the OSI Reference Model layers. As a result, switched traffic is faster than routed traffic. Because routed traffic is slower than switched traffic, it may be advantageous from a business perspective to route only the traffic that cannot be accommodated using switching. Such traffic is carried on a routing wavelength and routed from source to destination.

Traffic can be transported on explicitly switched paths. FIG. 5 shows a backbone 500 that has the Seattle node 102 linked to the New York node 104 and the Los Angeles node 108, the New York node 104 linked to the Miami node 106, and the Miami node 106 linked to the Los Angeles node 108. The Denver node 110 is linked between the Los Angeles node 108 and the New York node 104. For purpose of illustration suppose that the service provider receives a request from a customer serviced by the Miami node 106 to hold a teleconference with a customer serviced by the Seattle node 102, which will last four hours from two p.m. to six p.m. Suppose further that the traffic between the Seattle node 102 and the New York node 104 utilizes one hundred percent of allocated bandwidth and its path is allocated a switching wavelength.

One embodiment of the present invention the Seattle node 102 explicitly sets up a path for the teleconference traffic and signals all intermediate nodes between the source and destination to provide a switched path for the teleconference traffic. For example the Seattle node 102 can send a control packet to the Los Angeles node 108, the Denver node 110, and the Miami node 106 that from two p.m. to ten p.m. fifty percent of the bandwidth of the Los Angeles node 108, the Denver node 110, and the Miami node 106 is being utilized for the teleconference and is not available to the Los Angeles node 108, the Denver node 110, or the Miami node 106.

The arrow 502 illustrates the explicitly switched path between the Seattle node 102 and the Miami node 106 via the Los Angeles node 108 and the Denver node 110. The arrow 504 illustrates the statically switched path between the Seattle node 102 and the New York node 104. The arrow 506 illustrates the statically switched path between the Seattle node 102 and the New York node 104.

The control packet implementation is protocol specific and its implementation will be readily apparent to a person of ordinary skill in the relevant art(s). For example, when the protocol is RSVP, an RSVP control packet is used. Similarly, when the protocol is Optical Burst Switching, an Optical Burst Switching control packet is used.

The switched bandwidth for the teleconference is dynamically reserved. The switching is accomplished using switching wavelengths such that all teleconference traffic is labeled with switching wavelengths. At the end of the time period, the reserved bandwidth may be automatically released for use by the Los Angeles node 108, the Denver node 110, and the Miami node 106. As is the case in static provisioning, other traffic in the network 100 may be routed on routing wavelengths.

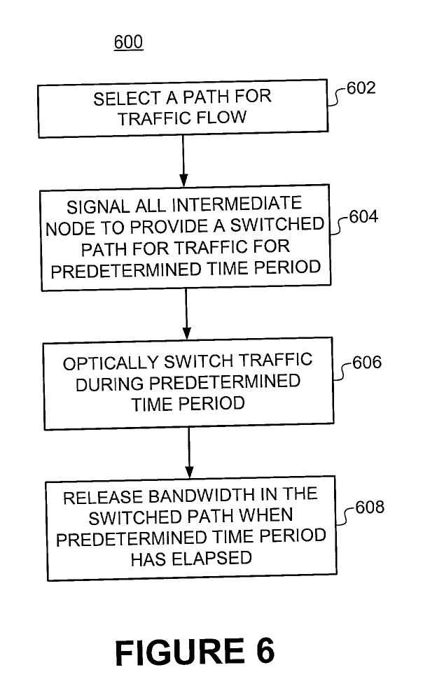

Explicit provisioning is typically performed dynamically. FIG. 6 is a flowchart illustrating a process 600 to implement an example approach to explicit provisioning. In step 602, the ingress node selects a path for traffic flow. In step 604, the ingress node signals all intermediate nodes in the selected path to provide a switched path for the traffic for a predetermined time. In step 606, traffic is optically switched from node to node according to the selected path during the predetermined time. In step 608, the predetermined time elapses and the nodes in the selected path release bandwidth in their portions of the switched path.

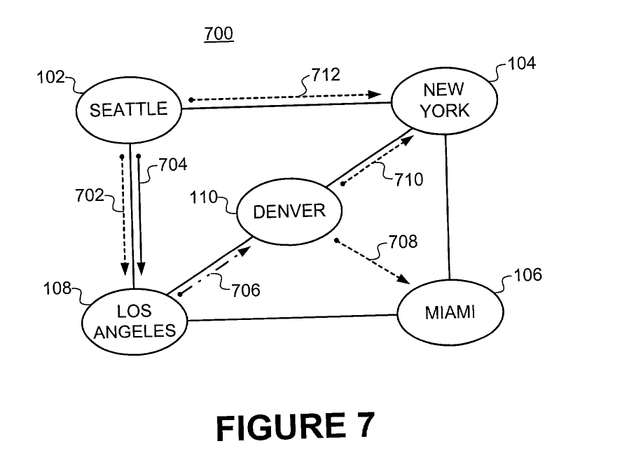

Traffic can be transported on shared paths. FIG. 7 shows a backbone 700 that has the Seattle node 102 linked to the New York node 104 and the Los Angeles node 108, the New York node 104 linked to the Miami node 106, and the Miami node 106 linked to the Los Angeles node 108. The Denver node 110 is linked between the Los Angeles node 108 and the New York node 104. For purpose of illustration suppose that two data streams intended for two destinations arrive at the Seattle node 102. Suppose further that the traffic between the Seattle node 102 and the New York node 104 is one hundred ten percent of allocated bandwidth and ten percent is non-critical traffic and traffic between the Seattle node 102 linked and the Los Angeles node 108 is thirty percent of allocated bandwidth.

One embodiment of the present invention, the non-critical traffic between the Seattle node 102 and the New York node 104 is partially routed and partially switched. For example, as for the non-critical traffic, the Seattle node 102 dynamically sets up an explicit switched path between the Seattle node 102 and the Los Angeles node 108. The Los Angeles node 108 routes the non-critical traffic to the Denver node 110. The Denver node 110 dynamically sets up an explicit switched path to the New York node 104.

As for the traffic between the Seattle node 102 and the Los Angeles node 108 that is thirty percent of allocated bandwidth, the Seattle node 102 dynamically sets up an explicit path to the Los Angeles node 108. The Los Angeles node 108 routes the ten percent of the non-critical traffic to the Denver node 110 using one or more routing wavelengths.

The arrow 702 illustrates the switched path for the ten percent of the noncritical traffic between the Seattle node 102 and the New York node 104 sent to the Los Angeles node 108. The arrow 704 illustrates the switched path for the traffic between the Seattle node 102 and the Los Angeles node 108 that is thirty percent of allocated bandwidth. The arrow 706 illustrates the routed path between the Los Angeles node 108 and the Denver node 110 for the ten percent of the noncritical traffic. The arrow 708 illustrates the switched path between the Denver node 110 and the Miami node 106 for Miami traffic. The arrow 710 illustrates the switched path for the ten percent of the non-critical traffic between the Denver node 110 and the New York node 104. The arrow 712 illustrates the statically switched path between the Seattle node 102 and the New York node 104.

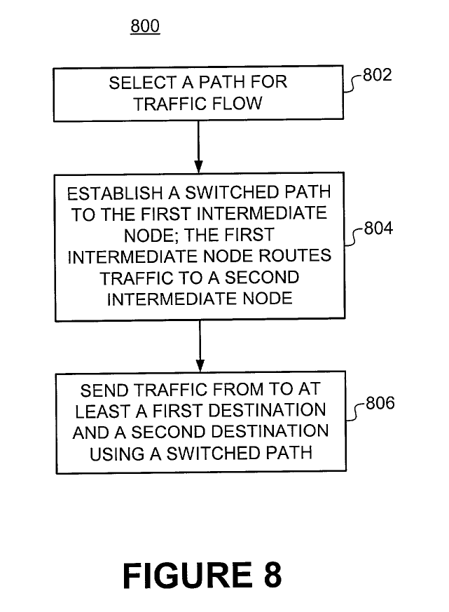

Shared provisioning is typically performed dynamically. FIG. 8 is a flowchart illustrating a process 800 to implement an example approach to explicit provisioning. In step 802, the ingress node selects a path for traffic flow. In step 804, the ingress node establishes a switched path to the first intermediate node, which then routes the traffic to the second intermediate node. In step 806, the second intermediate node sends the traffic from the first intermediate node on at least two switched paths to destination nodes. In one embodiment, as the bandwidth utilization changes, the assignments of switching wavelengths and routing wavelengths may be changed to accommodate the new bandwidth.

Aspects of the invention can be implemented using hardware, software, or a combination of hardware and software. Such implementations include state machines and application specific integrated circuits (ASICs). In implementations using software, the software may be stored on a machine-readable medium, e.g., a computer program product (such as an optical disk, a magnetic disk, a floppy disk, etc.) or a program storage device (such as an optical disk drive, a magnetic disk drive, a floppy disk drive, etc.).

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for provisioning bandwidth in a hybrid network, comprising:
assigning a set of switching wavelengths to traffic in the network; and
optically switching the traffic between nodes using the set of switching wavelengths.

2. The method of claim 1, further comprising:
identifying critical nodes in the network;
establishing at least one static path between the identified critical nodes; and
optically switching traffic on the static path using the set of switching wavelengths.

3. The method of claim 1, further comprising:
dynamically selecting a path for traffic flow;
signaling downstream nodes in the path to establish and maintain the selected path for a predetermined time period;
optically switching traffic on the selected path during the predetermined time period using the set of switching wavelengths; and
releasing the selected path after the predetermined time period elapses.

4. The method of claim 1, further comprising:
assigning a set of routing wavelengths to a portion of the traffic in the network; and
routing the portion of traffic between nodes using the set of routing wavelengths.

5. The method of claim 1, further comprising:
statically assigning a set of switching wavelengths to traffic in the network; and
optically switching the traffic between nodes using the set of switching wavelengths.

6. The method of claim 1, further comprising:
dynamically assigning a set of switching wavelengths to traffic in the network; and
optically switching the traffic between nodes using the set of switching wavelengths.

7. A method for sharing bandwidth in a hybrid network, comprising:
labeling traffic to be switched in the network with a set of switching wavelengths;
labeling traffic to be routed in the network with a set of routing wavelengths; and
optically switching the traffic labeled with switching wavelengths; and
routing the traffic labeled with routing wavelengths.

8. The method of claim 7, further comprising:
optically switching the traffic labeled with switching wavelengths using optical circuit switching; and
routing the traffic labeled with routing wavelengths using Internet Protocol (IP) routing.

9. The method of claim 8, further comprising:
converting the traffic labeled with routing wavelengths from an optical domain to an electrical domain;
processing the traffic labeled with routing wavelengths in the electrical domain; and
converting the traffic labeled with routing wavelengths back to the optical domain from the electrical domain.

10. The method of claim 7, further comprising:
optically switching the traffic labeled with switching wavelengths using a wavelength network element, an optical cross-connect, an optical network element, an optical switch, a lambda switch, a lambda network element, or a wavelength translator.

11. The method of claim 7, further comprising:
routing the traffic labeled with routing wavelengths using Open Shortest Path First (OSPF), Resource Reservation Protocol (RSVP), or Border Gateway Protocol (BGP).

12. The method of claim 7, further comprising:
routing the traffic labeled with routing wavelengths using an Internet Protocol (IP), asynchronous transport mode (ATM), or frame relay.

13. The method of claim 7, further comprising:
labeling traffic to signal and transfer control information updates in the network with a set of control wavelengths; and
exchanging routing updates using the set of control wavelengths.

14. The method of claim 7, further comprising:
labeling traffic to signal and transfer control information updates in the network with a set of control wavelengths;
appending labeling information on routing updates;
exchanging routing updates and labeling information using the set of control wavelengths; and
generating a label map from the routing updates and labeling information.

15. An apparatus to communicate in a hybrid network, comprising:
switching logic to optically switch traffic carried on a set of switching wavelengths;
routing logic coupled to the switching logic to route traffic carried on a set of routing wavelengths; and
control logic coupled between the switching logic and the routing means for receiving information carried on a set of control wavelengths to determine whether traffic is directed to the switching logic or the routing logic.

16. The apparatus of claim 15 wherein the switching logic is further to:
dynamically select a path for traffic flow;
signal downstream nodes in the path to establish and maintain the selected path for a predetermined time period;
optically switch traffic on the selected path during the predetermined time period using the set of switching wavelengths; and
release the selected path after the predetermined time period elapses.

17. The apparatus of claim 15 wherein the switching logic is further to:
assign a set of routing wavelengths to a portion of the traffic in the network; and
route the portion of traffic between nodes using the set of routing wavelengths.

18. The apparatus of claim 15 wherein the switching logic is further to:
statically assign a set of switching wavelengths to traffic in the network; and
optically switch the traffic between nodes using the set of switching wavelengths.

19. The apparatus of claim 15 wherein the switching logic is further to:
dynamically assign a set of switching wavelengths to traffic in the network; and
optically switch the traffic between nodes using the set of switching wavelengths.

20. A hybrid communication network, comprising:
a first hybrid node to label switched traffic with a set of switching wavelengths, to send the switched traffic to at least one secondary hybrid node via the set of switching wavelengths, to label routed traffic with a set of routing wavelengths, to send the routed traffic to at least one secondary hybrid node via the set of routing wavelengths;
at least one secondary hybrid node coupled to the first hybrid node to receive the switched traffic on the set of switching wavelengths and routed traffic on the set of routing wavelengths, to route the routed traffic using an Internet Protocol (IP), asynchronous transport mode (ATM), or frame relay, and to optically circuit switch the switched traffic and the routed traffic to another secondary node.

21. The system of claim 20 wherein the first and secondary hybrid nodes further comprise a wavelength network element, an optical cross-connect, an optical network element, an optical switch, a lambda switch, a lambda network element, or a wavelength translator.

22. The system of claim 20 wherein the first and secondary hybrid nodes each further comprises logic to receive routing updates and label information via a set of control wavelengths, to generate a label map from the routing updates and labeling information, to generate a switching matrix using the label map.

23. The system of claim 20 wherein the first and secondary hybrid nodes each further comprises logic to store routing.
